(19) United States
(12) Patent Application Publication
(10) Pub. No.: US 2026/0138315 A1
(43) Pub. Date: May 21, 2026

(54) INJECTION MOLDING METHOD OF MASSAGE ROLLER

(71) Applicant: YUN YANG INDUSTRIAL CO., LTD., Taichung City (TW)

(72) Inventor: SHIH-CHANG CHEN, Taichung City (TW)

(21) Appl. No.: 18/954,099

(22) Filed: Nov. 20, 2024

(51) Int. Cl. B29C 45/14; B29L 23/00; B29L 31/32

(52) U.S. Cl. CPC B29C 45/14622; B29L 2023/00; B29L 2031/32

(57) ABSTRACT

The present application provides an injection molding method of a massage roller, including following steps: providing a hollow shaft tube; placing the hollow shaft tube in a mold of an injection molding device, with a formation space arranged between the hollow shaft tube and the mold; and injecting a molding material into the formation space along a direction perpendicular to an axis of the hollow shaft tube, thereby forming a coating layer on an outer circumference of the hollow shaft tube, finishing the massage roller. Therefore, the present application reduces the occurrence of seam lines and burrs on the product surface.

### BACKGROUND OF THE APPLICATION

### 1. Field of the Application

The present application relates to injection molding methods, and more particularly, to an injection molding method of massage roller.

### 2. Description of the Related Art

Appropriate massage provides temporary stimulation to the muscles and fascia of human body, thereby achieving relaxation and promoting blood circulation. To further improve the effects of massage, rollers are often used as auxiliary tools to effectively remove accumulation of lactic acid after exercise and to relax and relieve muscle soreness.

Referring to FIG. 1, a schematic view of a conventional injection molding method of a massage roller is illustrated. Mainly, before molding, a hollow tube 1 is placed in a mold 2. Then, a nozzle 3 of an injection molding machine is applied for injecting a plastic raw material into a gate 2a of the mold 2 to form a surface layer 4 around the outer circumference of the hollow tube 1, such that the surface layer 4 wraps the hollow tube 1, completing the production of the massage roller.

However, the position of the gate 2a in the conventional technique is located at one end along the axial direction of the hollow tube 1. When the plastic raw material is injected into the mold cavity through the gate 2a, the portion of the plastic raw material near the gate 2a cools and solidifies first, while the portion of the plastic raw material farther from the gate 2a will solidify later. Such uneven cooling rate easily cause visible seam lines or burrs on the surface of the surface layer 4, affecting the appearance of the product. Moreover, such defects may result in stress concentration within the massage roller, so as to reduce the strength of the product.

### SUMMARY OF THE APPLICATION

To improve the issues above, an injection molding method of massage roller is provided, which injects the molding material along a direction perpendicular to the axis of the hollow shaft tube, such that the molding material completely covers the outer circumference of the hollow shaft tube, whereby effectively reduce the seam lines and burrs of conventional massage rollers, improving the appearance and service life of the product.

To achieve the objectives, the present application provides an injection molding method of a massage roller, comprising following steps:
providing a hollow shaft tube;
placing the hollow shaft tube in a mold of an injection molding device, with a formation space arranged between the hollow shaft tube and the mold; and
injecting a molding material into the formation space along a direction perpendicular to an axis of the hollow shaft tube, thereby forming a coating layer on an outer circumference of the hollow shaft tube, finishing the massage roller.

In another embodiment, the injection molding device comprises a first mold base, a second mold base, a stripper plate, and a fix plate. The mold is arranged between the first mold base and the second mold base. The fix plate is arranged away from the second mold base, with the stripper plate disposed between the second mold base and the fix plate. The fix plate comprises a gate. The second mold base comprises an injection runner in communication with the gate. The mold comprises two guiding runners arranged in parallel to the axis. Each of the two guiding runners comprises an inlet and an outlet, respectively. The two inlets are in communication with the injection runner, and the two outlets are disposed on two sides of the hollow shaft tube. The two outlets are arranged in perpendicular to the axis and in communication with the formation space.

In another embodiment, the gate is in communication with the injection runner through a flow channel. The injection runner comprises a main runner and two branch runners. The main runner is perpendicularly in communication with the flow channel. The two branch runners are in communication with two ends of the main runner and the two inlets, respectively.

In another embodiment, after the massage roller is formed, a cold material is formed in the injection runner and the two guiding runners. The cold material includes a first cold material part and a second cold material part. The first cold material part is in the injection runner. The second cold material part is in the guiding runner. When the stripper plate is separated from the second mold base, the first cold material part is cut, such that the first cold material part is separated from the second cold material part.

In another embodiment, when the first mold base and the second mold base are separated, the mold is opened, and the second cold material part is separated from the massage roller, so that the massage roller is taken out.

In another embodiment, the hardness of the hollow shaft tube is greater than the hardness of the coating layer.

With such configuration, the method of the present application effectively shortens the flow path of the molding material in the mold, significantly reducing the unevenly cooling issue during the flowing process of the molding material, thereby reducing the seam lines and burrs on the surface and improving the smoothness of the product surface. Also, the evenly carried out cooling process effectively minimizes the internal stress concentration in the product, improving the structural strength and durability of the massage roller.

### BRIEF DESCRIPTION OF THE DRAWINGS

FIG. 1 is a schematic view of a conventional injection molding method of massage roller.

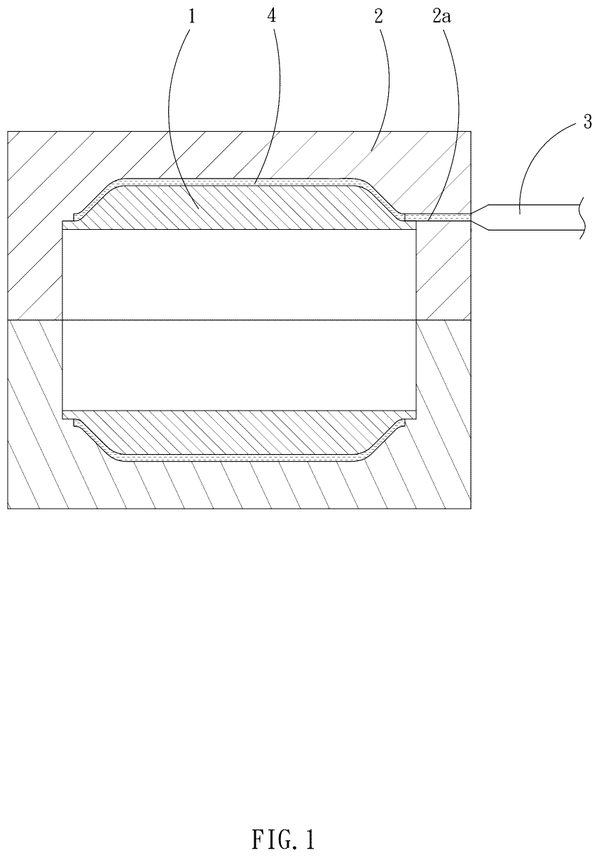

FIG. 2 is a flow chart of the injection molding method of massage roller in accordance with an embodiment of the present application.

FIG. 3 is a perspective view of the injection molding device used by the injection molding method of massage roller in accordance with an embodiment of the present application.

FIG. 4 is a cross-sectional view taken along line A-A in FIG. 3.

FIG. 5 is a schematic view illustrating the material injection operation of the injection molding method of massage roller in accordance with an embodiment of the present application.

FIG. 6 is a schematic view illustrating the first cold material part cutting operation of the injection molding method of massage roller in accordance with an embodiment of the present application.

FIG. 7 is a schematic view illustrating the second cold material part cutting and mold opening operation of the injection molding method of massage roller in accordance with an embodiment of the present application.

FIG. 8 is a perspective view of the massage roller in accordance with the present application.

### DETAILED DESCRIPTION OF THE APPLICATION

The aforementioned and further advantages and features of the present application will be understood by reference to the description of the preferred embodiment in conjunction with the accompanying drawings where the components are illustrated based on a proportion for explanation but not subject to the actual component proportion. Embodiments of the present application are illustrated in detail along with the drawings. However, the technical features included by the present application are not limited to certain embodiments hereby provided. Scope of the present application shall be referred to the claims, which include all the possible replacements, modifications, and equivalent features.

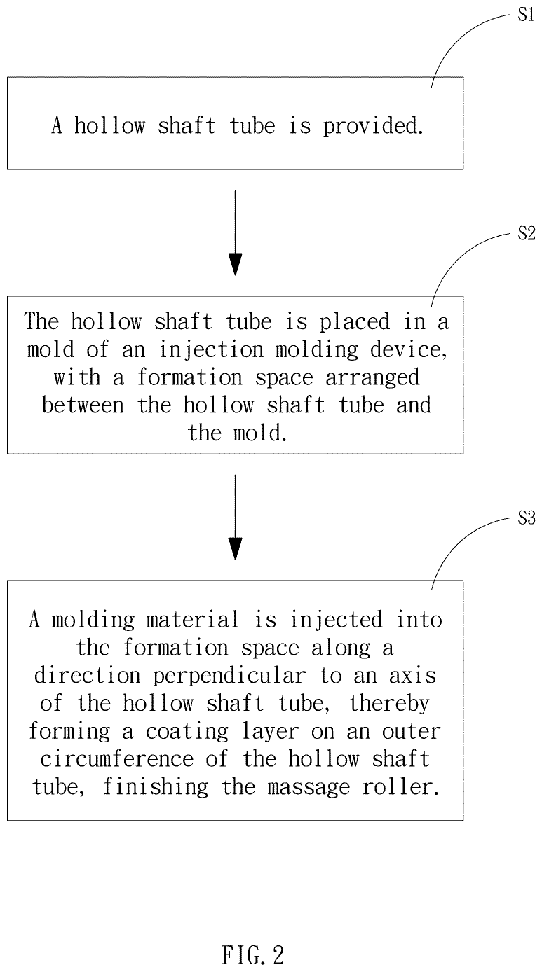

Referring to FIG. 2 to FIG. 8, the present application provides an injection molding method of massage roller, comprising following steps.

In step S1, a hollow shaft tube 10 is provided. Therein, an outer circumference of the hollow shaft tube 10 is formed in a concave and convex shape along an axis X.

In step S2, the hollow shaft tube 10 is placed in a mold 20 of an injection molding device 100, with a formation space 21 formed between the hollow shaft tube 10 and the mold 20.

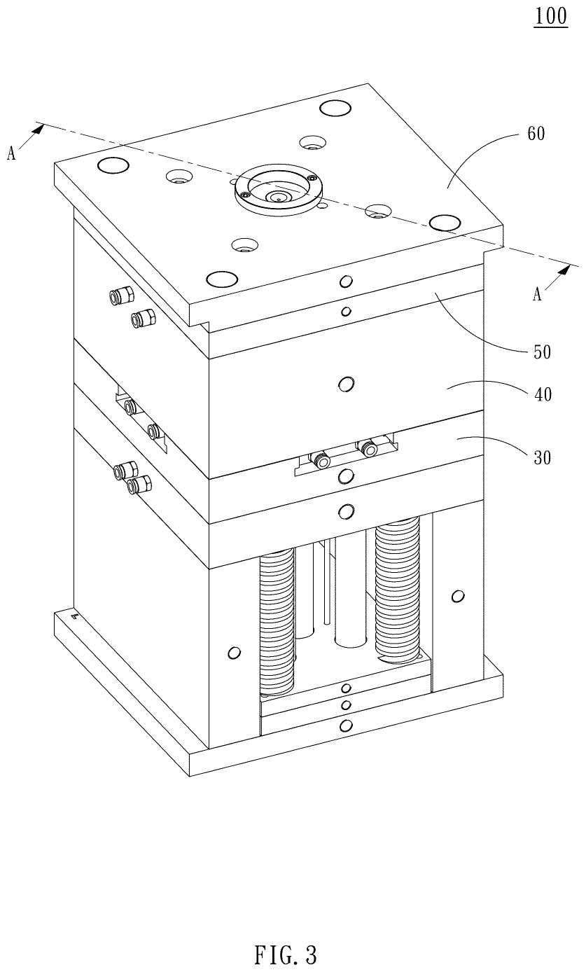

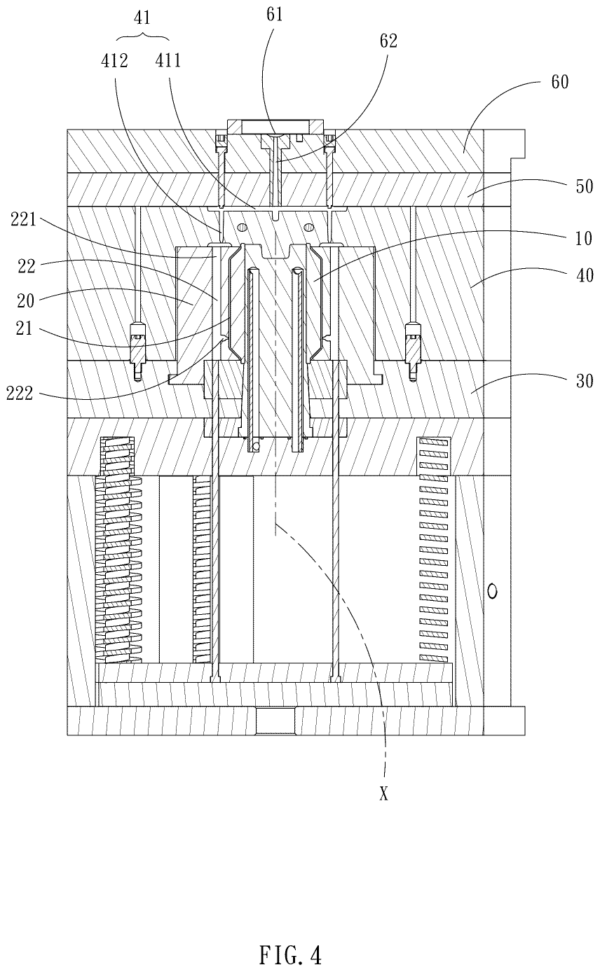

Referring to FIG. 3 and FIG. 4, in the embodiment, the injection molding device 100 comprises a first mold base 30, a second mold base 40, a stripper plate 50, and a fix plate 60. The mold 20 is formed by a combination of four half-molds and disposed between the first mold base 30 and the second mold base 40. The fix plate 60 is arranged away from the second mold base 40. The stripper plate 50 is disposed between the second mold base 40 and the fix plate 60. Therein, the fix plate 60 comprises a gate 61 to be cooperated with a nozzle 3 of an injection machine. The second mold base 40 comprises an injection runner 41 in communication with the gate 61. The gate 61 is in communication with the injection runner 41 through a flow channel 62.

The injection runner 41 comprises a main runner 411 and two branch runners 412 in communication with two ends of the main runner 41. The main runner 41 is perpendicularly in communication with the flow channel 62. The mold 20 comprises two guiding runners 22 arranged in parallel to the axis X. Each of the two guiding runners 22 comprises an inlet 221 and an outlet 222, respectively. The two inlets 221 are in communication with the two branch runners 412 of the injection runner 41, and the two outlets 222 are disposed on two sides of the hollow shaft tube 10. The two outlets 222 are arranged in perpendicular to the axis X and in communication with the formation space 21.

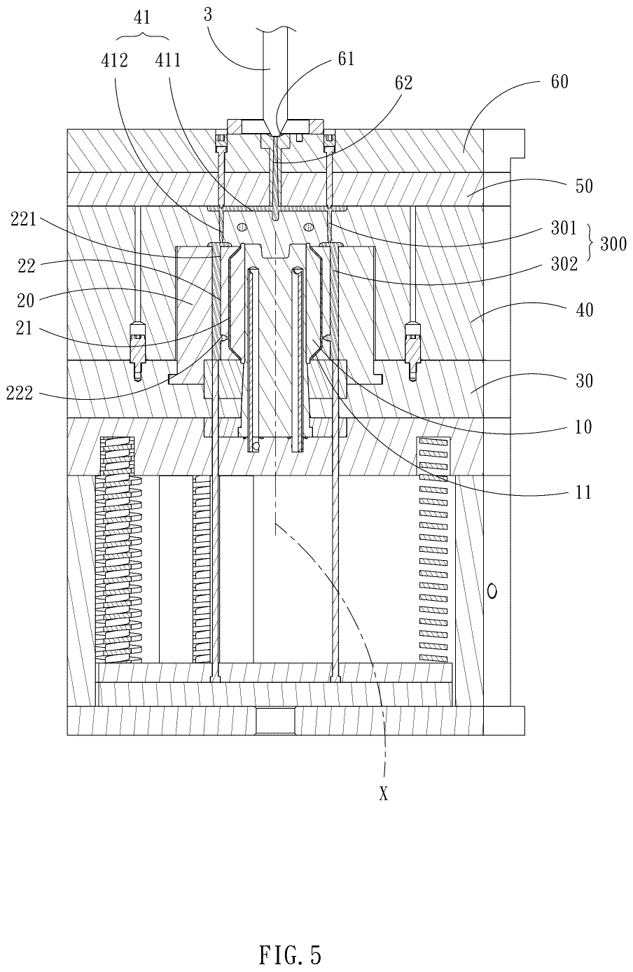

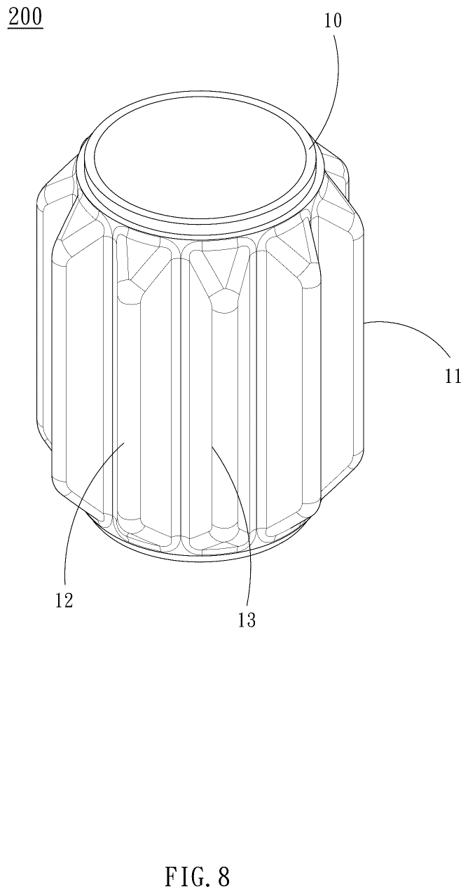

In step S3, a molding material is injected into the formation space 21 along a direction perpendicular to the axis X of the hollow shaft tube 10, thereby forming a coating layer 11 on the outer circumference of the hollow shaft tube 10, finishing a massage roller 200, as shown in FIG. 8. Referring to FIG. 5, in the embodiment, the nozzle 3 of the injection machine is arranged in alignment with the gate 61 for injecting the molding material, so that the molding material is diverted to the two guiding runners 22 through the injection runner 41, and then injected into the formation space 21 along the direction perpendicular to the axis X, thereby forming the coating layer 11 on the outer circumference of the hollow shaft tube 10.

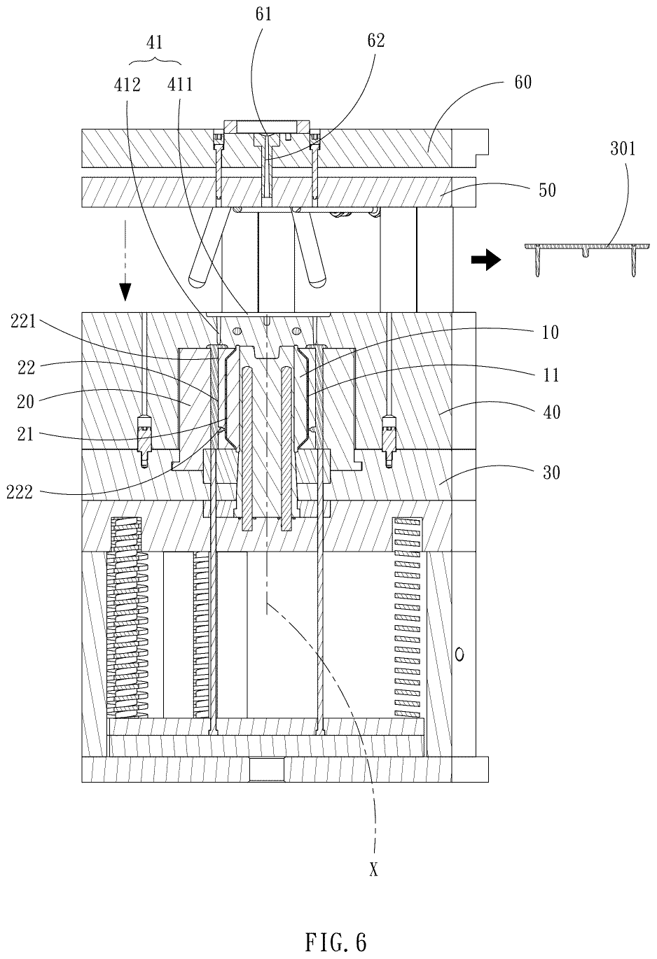

Then, referring to FIG. 6, after the formation of the massage roller 200, a cold material 300 is formed in the injection runner 41 and the two guiding runners 22. The cold material 300 comprises a first cold material part 301 and a second cold material part 302. The first cold material part 301 is in the injection runner 41. The second cold material part 302 is in the guiding runner 22. Accordingly, when the product if separated from the second mold base 40 by use of the stripper plate 50, the first cold material part 301 is cut, so that the first cold material part 301 is separated from the second cold material part 302.

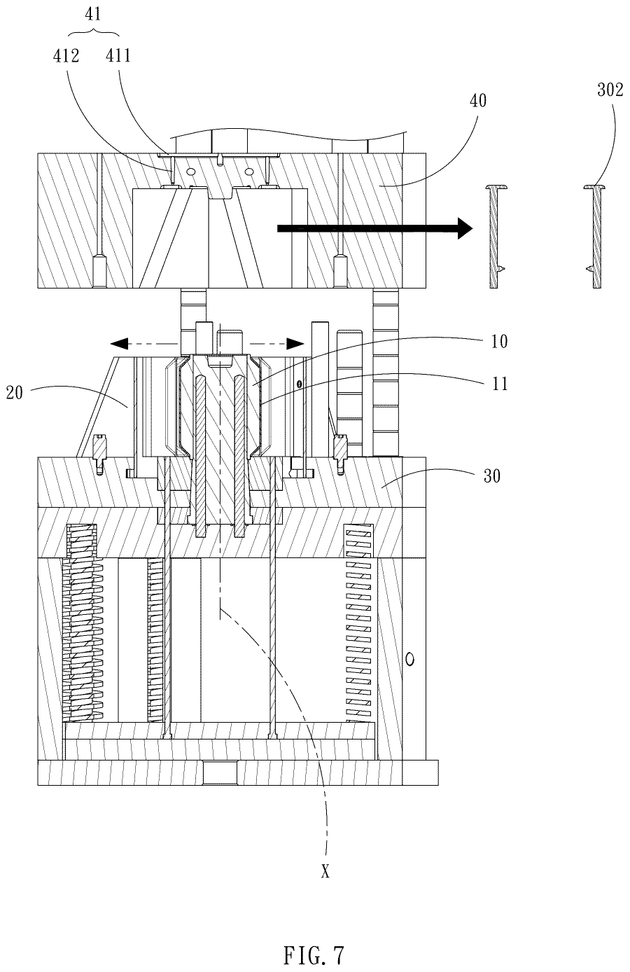

Referring to FIG. 7 in view of FIG. 6 and FIG. 8, when the first cold material part 301 is separated from the second cold material part 302, the first mold base 30 is separated from the second mold base 40, and the mold 20 is opened, so that the second cold material part 302 is separated from the massage roller 200, facilitating the removal of the massage roller 200. the hardness of the hollow shaft tube 10 is greater than the hardness of the coating layer 11. Also, a plurality of ribs 12 and a plurality of grooves 13 are distributed on an outer circumference of the massage roller 200 along the axis X in an alternating arrangement.

In the aforementioned steps, the injection direction is arranged in perpendicular to the direction of the axis X, so as to reduce the flowing distance of the molding material in the mold 20, thereby lowering the uneven cooling of the molding material during the flowing process, so as to reduce the occurrence of seam lines and burrs, and improve the smoothness of the product surface. Also, the evenly carried out cooling process effectively minimizes the internal stress concentration in the product, improving the structural strength and durability of the massage roller 200.

Although particular embodiments of the application have been described in detail for purposes of illustration, various modifications and enhancements may be made without departing from the spirit and scope of the application. Accordingly, the application is not to be limited except as by the appended claims.

What is claimed is:

1. An injection molding method of a massage roller, comprising following steps:
providing a hollow shaft tube;
placing the hollow shaft tube in a mold of an injection molding device, with a formation space arranged between the hollow shaft tube and the mold; and
injecting a molding material into the formation space along a direction perpendicular to an axis of the hollow shaft tube, thereby forming a coating layer on an outer circumference of the hollow shaft tube, finishing the massage roller.

2. The injection molding method of claim 1, wherein the injection molding device comprises a first mold base, a second mold base, a stripper plate, and a fix plate; the mold is disposed between the first mold base and the second mold base; the fix plate is arranged away from the second mold base; the stripper plate is disposed between the second mold base and the fix plate; the fix plate comprises a gate; the second mold base comprises an injection runner in communication with the gate; the mold comprises two guiding runners arranged in parallel to the axis; each of the two guiding runners comprises an inlet and an outlet, respectively; the two inlets are in communication with the injection runner; the two outlets are disposed on two sides of the hollow shaft tube; the two outlets are arranged in perpendicular to the axis and in communication with the formation space.

3. The injection molding method of claim 2, wherein the gate is in communication with the injection runner through a flow channel; the injection runner comprises a main runner and two branch runners; the main runner is perpendicularly in communication with the flow channel; the two branch runners are in communication with two ends of the main runner and the two inlets, respectively.

4. The injection molding method of claim 3, wherein after the massage roller is formed, a cold material is formed in the injection runner and the two guiding runners; the cold material includes a first cold material part and a second cold material part; the first cold material part is in the injection runner; the second cold material part is in the guiding runner; when the stripper plate is separated from the second mold base, the first cold material part is cut, such that the first cold material part is separated from the second cold material part.

5. The injection molding method of claim 4, wherein when the first mold base and the second mold base are separated, the mold is opened, and the second cold material part is separated from the massage roller, so that the massage roller is allowed to be taken out.

6. The injection molding method of claim 5, wherein a hardness of the hollow shaft tube is greater than a hardness of the coating layer.
